(19) United States
(12) Patent Application Publication
(10) Pub. No.: US 2026/0112563 A1
(43) Pub. Date: Apr. 23, 2026

(54) Electrical protection device, distribution assembly and associated electrical panel

(71) Applicant: Schneider Electric Industries, SAS, Rueil Malmaison (FR)

(72) Inventors: Claude BURNOT, Echirolles (FR); Pascal Auger, Gières (FR); Robin Schwaar, 38640 (FR); Dider Badin, Saint Martin d'Hères (FR); Louis Linares, La Terrasse (FR)

(21) Appl. No.: 19/364,319

(22) Filed: Oct. 21, 2025

(30) Foreign Application Priority Data
Oct. 21, 2024 (FR) FR2411462

(51) Int. Cl. H01H 73/60; H01H 9/26; H01H 71/00; H01H 71/02; H01H 71/12; H01H 71/52; H02B 1/056

(52) U.S. Cl. CPC H01H 73/60; H01H 9/26; H01H 71/002; H01H 71/0207; H01H 71/126; H01H 71/52; H02B 1/056; H01H 2071/0292

(57) ABSTRACT

This electrical protection device (300) is configured to be reversibly mounted on a distribution device (110) comprising a power bus (124). The device for protecting the incoming terminals (302), connectable to the power bus, and a switching mechanism (310) with a movable contact (370) and a tripping device (372). The protection device comprises a safety mechanism (500), which comprises a support portion (502), which is movable and which is configured to be pushed back, against a return member (504), into a retracted position when the protection device is mounted on the distribution device. When the protection device is dismantled, the support portion moves and the safety device activates the tripping device (372), causing the switching mechanism to switch to an isolation configuration before each incoming terminal is disconnected from the power bus.

### BACKGROUND

The present invention relates to an electrical protection device, to a distribution assembly comprising such a protection device, and to an electrical panel comprising such a distribution assembly.

An electrical installation generally comprises an electrical panel, or an electrical enclosure, that connects this electrical installation to an electrical distribution network and has various protection, control and monitoring devices for the electrical installation. The electrical protection devices are considered in this case to include protection devices, such as circuit breakers, which comprise contacts that are separable by a switching mechanism. The switching mechanism is generally able to be actuated manually via a handle, and also comprises a tripping device, also referred to as a trip bar, which is configured to switch the switching mechanism into the tripped configuration when the tripping device is excited by an electrical fault of a predetermined type. The tripping device is excited, for example, by movement of the tripping device. EP-4 064 317-A1 describes an example of such a protection device.

To make it easier to install and maintain electrical installations, the protection devices are modular, that is to say mounted on a distribution device comprising a power bus, in such a way as to jointly ensure that they are mechanically held and supplied with electric power. When a protection device is dismantled from the distribution device while a current is still flowing, there is a risk of electric arcs forming and damaging the protection device and/or the distribution device, this not being desirable.

It is these problems that the invention is intended more particularly to overcome, by providing a protection device that is both modular and exhibits improved safety.

### SUMMARY

To this end, the invention relates to an electrical protection device comprising:
a housing which is configured to be mounted, reversibly and by means of a mounting movement, on a distribution device comprising a power bus with at least one phase and optionally a neutral, the protection device then being in a mounted position in which a rear face of the housing is oriented towards the distribution device,
a first conducting path comprising:
   a first incoming terminal, which is configured to be connected to the power bus,
   a first outgoing terminal, which is configured to be connected to an electric load, and
   a first movable contact, which is movable with respect to the housing between a conducting position, in which the first movable contact electrically connects the first incoming terminal to the first outgoing terminal, and an isolating position, in which the first incoming terminal and the first outgoing terminal are electrically isolated from one another;
a switching mechanism, which is accommodated in the housing and which is configured to switch between:
   an armed configuration, in which the switching mechanism places the first movable contact in the conducting position, and
   a tripped configuration, in which the switching mechanism places the first movable contact in the isolating position;
      wherein:
the switching mechanism comprises a tripping device, which is movable between a neutral position and an excited position, the tripping device being configured to switch the switching mechanism into the tripped configuration when the tripping device is in the excited position;
the electrical protection device comprises a safety mechanism, which comprises:
   a support portion, which is movable between a retracted position and an advanced position, the support portion being accessible through a slot provided in the housing and being configured to be pushed back into the retracted position by the distribution device when the protection device is mounted on the distribution device by means of the mounting movement,
   a return member, which tends to return the support portion to the advanced position,
   a tripping portion, which is movable between an activating position, in which the tripping portion pushes the tripping device back from the neutral position to the excited position, and a set-back position, in which the tripping portion does not push back the tripping device,
   a transmission device, which connects the support portion to the tripping portion such that when the support portion is in the retracted position, the tripping portion is in the set-back position, the safety mechanism being in a set-back configuration, whereas when the support portion is in the advanced position, the tripping portion is in the activating position, the safety mechanism being in an activating configuration,
the safety mechanism is in the set-back configuration when the protection device is in the mounted position on the distribution device,
the safety mechanism is configured such that, during a dismantling movement, opposite to the mounting movement, the safety device passes from the set-back configuration to the activating configuration of the tripping device before the incoming terminal is disconnected from the power bus.

By virtue of the invention, each conducting circuit is open prior to the disconnection of the corresponding incoming terminal from the power bus, this preventing the occurrence of any electric arcs between the incoming terminal in question and the power bus. The dismantling of the protection device is safeguarded, even if the protection device was initially “hot”, that is to say in the armed configuration and with an electric current flowing through the conducting paths. Such a “hot” dismantling possibility is also referred to as a “hotswap”. When the protection device is dismantled from the distribution device, the return member keeps the safety device in the activating configuration; in other words, the tripping device is kept in the excited position, preventing the possibility of manually rearming the switching mechanism. It is therefore impossible to remount on the distribution device a protection device that is already in the armed configuration, this helping to improve safety during hot mounting of the protection device, that is to say during the mounting of the protection device on a power bus that is already energized.

According to advantageous but optional aspects of the invention, such a protection device may include one or more of the following features, taken individually or in any technically admissible combination:
The slot is provided in the rear face of the housing.
The housing comprises fastening members which are configured to cooperate, in particular by way of a form fit, with the distribution device such that the mounting movement is a rotational movement about a mounting axis situated close to a first edge of the rear face, while the slot is provided at a distance from the first edge.
The housing forms an internal volume, while the switching mechanism and the safety mechanism are jointly received in the internal volume.
The housing of the protection device is a modular housing which includes:
   a first housing, which receives the safety mechanism and which has a first orifice, through which an extension of the tripping portion protrudes,
   a second housing, which is different from the first housing and which receives the switching mechanism, while the first housing forms a cavity for receiving the second housing, the first housing and the second housing being configured to be joined together so as to form the housing of the protection device in an assembled configuration of the housing, the first housing has a first orifice, which leads into the cavity, while the safety mechanism comprises an extension, which is able to be activated by the tripping portion and which extends through the first orifice into the cavity, the extension being movable between a first position and a second position when the tripping portion travels between the activating position and the set-back position,
the second housing has a second orifice, which is situated facing the first orifice when the housing is in the assembled configuration,
and when the housing is in the assembled configuration, the extension extends into the second housing such that:
   when the tripping portion moves from the set-back position to the activating position, the tripping portion activates the extension, the extension moving from the first position to the second position,
   the extension pushes the tripping device back from the neutral position to the excited position.
The first housing comprises an auxiliary mechanism, which is a mechanical energy accumulation mechanism, which is switchable between an armed configuration and a tripped configuration, the extension being in the first position when the auxiliary mechanism is in the armed configuration, and in the second position when the auxiliary mechanism is in the tripped configuration, while the auxiliary mechanism is configured to switch from the armed configuration to the tripped configuration when the tripping portion moves from the set-back position to the activating position, and the auxiliary mechanism is configured to transmit to the extension enough force to switch the switching mechanism from the armed configuration to the tripped configuration.

The invention also relates to a distribution assembly comprising:
an example of the protection device as described above, and
a distribution device configured to distribute electrical energy coming from a power source to at least one electric load, the power source comprising at least one phase and optionally a neutral,
   wherein:
the distribution device comprises a power bus which comprises a plurality of conductor bars which include at least one phase bar and optionally a neutral bar, the neutral bar being associated with the neutral of the power source, each phase bar being associated with a respective phase of the power source,
the protection device is mounted on the distribution device, the support portion being pushed back into the retracted position by the distribution device, each incoming terminal being connected to the corresponding conductor bar.

Advantageously, the conductor bars extend parallel to one another along a main axis of the distribution device, and the conductor bars are provided for the simultaneous mounting of a plurality of examples of the protection device that are aligned alongside one another along the main axis.

The invention also relates to an electrical panel comprising:
a case delimiting an enclosure and having an end wall,
the distribution assembly as described above,
   wherein the distribution device is fastened to the end wall of the case.

### BRIEF DESCRIPTION OF THE DRAWINGS

The invention will be understood better, and further advantages thereof will become more clearly apparent in light of the following description of two embodiments of a protection device, of a distribution assembly and of an electrical panel, which are in accordance with the principle thereof, the description being given only by way of example and with reference to the appended drawings, in which:

FIG. 1 is a partially exploded perspective view of an electrical panel according to a first embodiment of the invention, the electrical panel comprising a distribution assembly, which is also in accordance with the invention;

FIG. 2 is a partially exploded perspective view of the distribution assembly in FIG. 1;

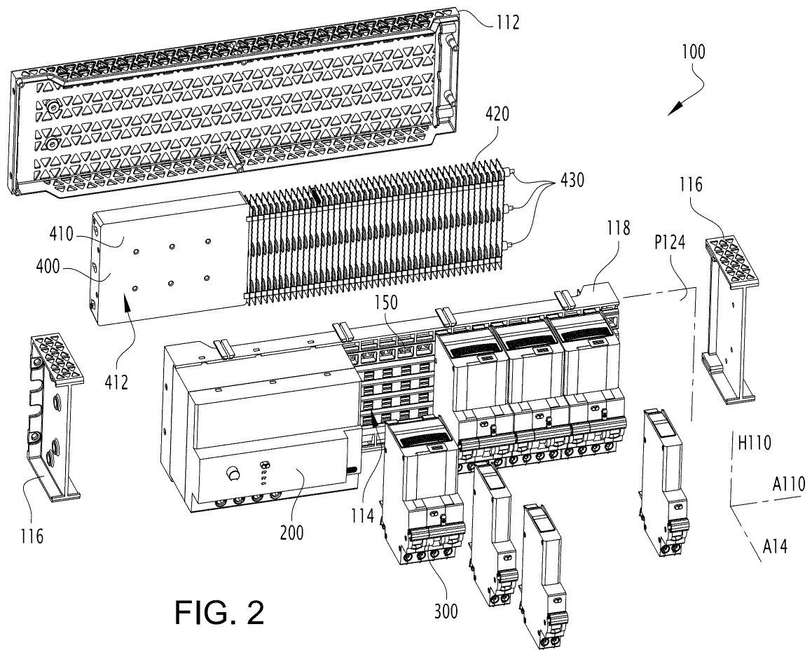

FIG. 3a and FIG. 3b respectively shows, in two inserts a) and b), a perspective view of the distribution assembly in FIG. 1, certain parts being hidden, and a perspective view of a transfer bus of the distribution assembly;

FIG. 4 is a partially exploded perspective view of the distribution assembly in FIG. 1, certain parts being hidden;

FIG. 5 is a schematic depiction of the distribution assembly in FIG. 1;

FIG. 6a and FIG. 6b shows, in two inserts a) and b), a perspective view and a cross section of the distribution device in FIG. 1, certain parts being hidden, the distribution device being shown in a first configuration;

FIG. 7a and FIG. 7b shows, in two inserts a) and b), a view similar to FIG. 6 b), the distribution device being in two other, different configurations;

FIG. 8a and FIG. 8b shows, in two inserts a) and b), a view similar to FIG. 6 b), the distribution device being in two other, different configurations;

FIG. 9a and FIG. 9b shows, in two inserts a) and b), a protection device belonging to a distribution assembly in accordance with a second embodiment of the invention, the protection device being shown in perspective and in a side view, respectively;

FIG. 10a and FIG. 10b respectively shows, in two inserts a) and b), two elements of the protection device in FIGS. 9a and 9b; and

FIG. 11 shows a side view of an element of the protection device in FIGS. 9a and 9b, certain parts being hidden.

### DETAILED DESCRIPTION

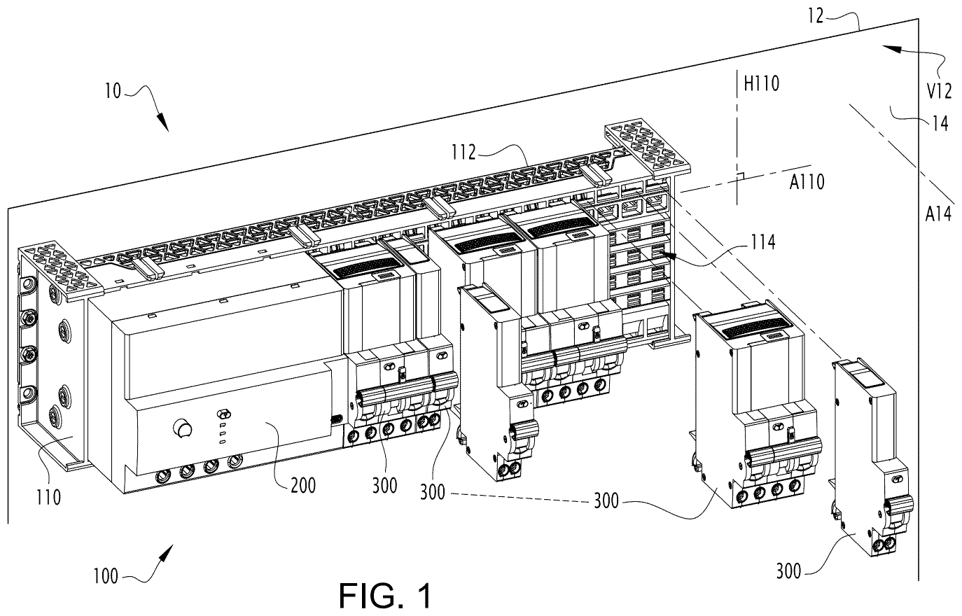

An electrical panel 10, in accordance with the invention, is shown in FIG. 1. The electrical panel 10 comprises a case 12, which delimits an enclosure V12 and which has an end wall 14. The end wall 14 extends overall in a plane orthogonal to a depth axis A14. The enclosure V12 is advantageously closed by a door, which is not depicted.

The electrical panel 10 comprises a distribution assembly 100. The distribution assembly 100 is fastened to the end wall 14 of the housing 12. The distribution assembly 100 is configured to distribute the electrical energy coming from a power source to at least one electric load, the power source comprising a neutral and at least one phase. In the example illustrated, the power source is a three-phase source, comprising a neutral and three phases. In a variant that is not illustrated, the power source is single-phase, comprising a neutral and one phase. According to another variant, the power source comprises three phases and no neutral. The power source and the electric load, which are not depicted, are not part of the invention but serve to explain the operating context thereof.

The distribution assembly 100 comprises a distribution device 110, via which the distribution assembly 100 is fastened to the end wall 14, a main housing 200, which is joined to the distribution device 110, preferably reversibly, and at least one protection device 300. In the example illustrated, the distribution assembly 100 comprises seven protection devices 300, which in this case are outgoing housings. The rest of the description is given for the case in which the protection devices 300 are outgoing housings, the principles of the invention being transposable to other types of protection device. Each protection device 300 is joined to the distribution device 110 reversibly, in a mounted position of the outgoing device 300. It is thus possible to replace, as required, the main housing 200 in the event of a malfunction of the main housing 200, while keeping the other elements of the distribution assembly 100, distribution device 110 and outgoing housing(s) 300, this being economical. Similarly, it is possible to replace, as required, one or more of the protection devices 300, for example in the event of a malfunction, while keeping the other elements, distribution device 110 and main housing 200, this being economical.

The distribution device 110 has an elongate shape which extends along a main axis A110. When the distribution assembly 100 is in a normal operating configuration, the main axis A110 is parallel to the end wall 14, in other words orthogonal to the depth axis A14. Preferably, the main axis A110 is horizontal, as illustrated in FIG. 1. A height axis H110 is defined as being an axis orthogonal both to the depth axis A14 and to the main axis A110. The description is given in relation to the orientation of the various elements as shown in the figures, although it may be different in reality.

In the example in FIG. 1, the main housing 200 is situated on the left-hand side of the distribution assembly 100, the protection devices 300 being situated on the right-hand side of the main housing 200.

When the distribution assembly 100 is fastened to the end wall 14, a rear portion 112 of the distribution device 110 is oriented towards the end wall 14, in other words oriented in a rearward direction of the distribution assembly 100. The rearward direction is thus parallel to the depth axis A14. A forward direction is also defined as being a direction opposite to the rearward direction.

The distribution device 110 thus has a mounting face 114, which is oriented overall towards the front and which is provided for mounting the main housing 200 and each protection device 300.

The rear portion 112 is made of an electrically insulating material, for example of synthetic polymer. The rear portion 112 in this case has a rectangular overall shape, which extends, along its longest dimension, parallel to the main axis A110. The short sides of the rectangle are thus parallel to the height axis H110. The distribution device 110 in this case comprises two flanges 116, which are made of an electrically insulating material. The two flanges 116 are joined to the short sides of the rear portion 112 so as to form a basket.

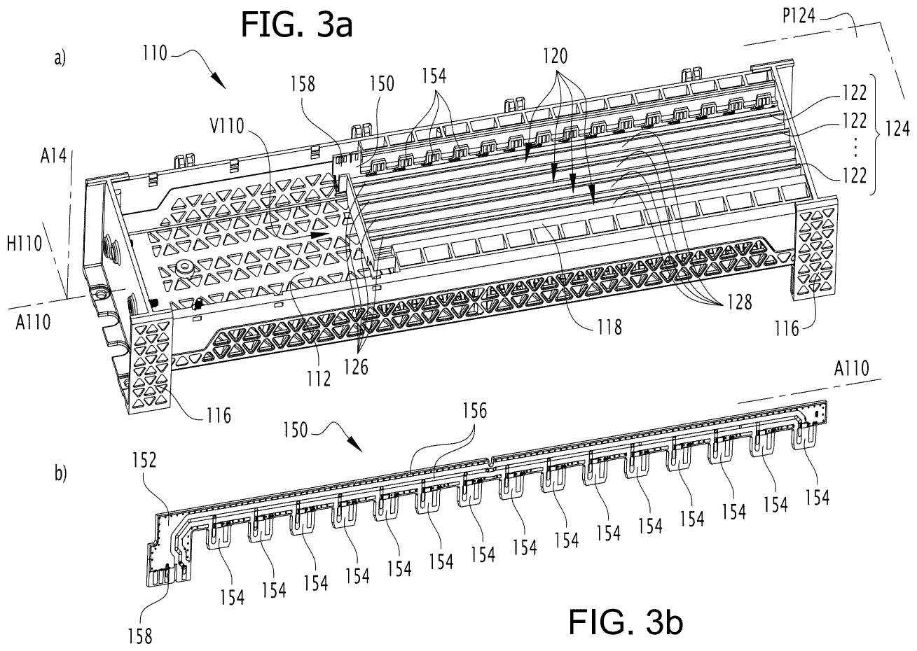

The distribution device 110 in this case comprises an insulating wall 118, which is made of an electrically insulating material and which is joined to the rear portion 112 and to the flanges 116 so as to form a cavity V110, as illustrated in FIGS. 3a and 3b.

In the example illustrated, the distribution device 110 advantageously comprises a cooling device 400, which is received in the cavity V110 and which is provided to discharge part of the heat generated by the main housing 200 when the distribution assembly 100 is in operation. The cooling device 400 is thus situated on a rear side of the insulating wall 118, while on a front side of the insulating wall 118, the front side being oriented away from the rear side, the insulating wall 118 forms grooves 120 provided to receive a plurality of conductor bars 122, in this case four conductor bars 122. The conductor bars 122 jointly form a power bus 124 of the distribution device 110 and, by extension, of the distribution assembly 100. The distribution device 110 is thus a power distribution device. The rear portion 112 is preferably perforated, so as to promote cooling, by convection, of the cooling device 400. The distribution device 110 thus forms a cage around the cooling device 400. The rear portion 112 is configured to ensure a protection index IP20, as defined by the standard CEI 60529—incorporated into the standard EP 60529:1992—, that is to say to prevent any direct contact between a user and the various parts of the cooling device 400, which tend to heat up.

The conductor bars 122 extend parallel to one another along the main axis A110 of the distribution assembly 100 and are aligned along the height axis H110. The conductor bars 122 jointly define a connection plane P124, which is a plane orthogonal to the depth axis A14, in other words parallel to the height axis H110 and to the main axis A110. The mounting face 114 is overall parallel to the connection plane P124.

The cooling device 400 comprises a contact plate 410, which is provided to capture part of the heat released by the main housing 200, a radiator 420, which is provided to dissipate the heat into the ambient air, and at least one heat pipe 430, in this case three heat pipes, which connects the contact plate 410 to the radiator 420 and which is configured to transfer to the radiator 420 part of the heat captured by the contact plate 410.

The contact plate 410 in this case has a parallelepipedal shape and has a contact face 412, which extends parallel to the connection plane P124. The contact face 412 is configured to cooperate, in particular by way of a form fit, with a rear face 230 of the main housing 200 in the configuration mounted on the distribution device 110, so as to promote heat transfer between the contact plate 410 and the main housing 200.

The radiator 420 is in this case formed of a set of metallic fins, which are positioned parallel to one another and which are aligned along the main axis A110. The heat pipes 430 connect the fins to the contact plate 410. Preferably, the heat pipes 430 are two-phase heat pipes. For example, the two-phase heat pipes 430 comprise two coaxial tubes, which are arranged so as to promote, within them, a circulation of heat-transfer fluid that changes phase, liquid or gas, depending on its temperature. Preferably, the heat pipes 430 are rectilinear and are arranged horizontally when the distribution assembly 100 is in a normal operating configuration. In other words, the main axis A110 is preferably horizontal.

Thus, the radiator 420 extends along the connection zone of the power bus 124, on a rear side of the connection plane P124. In particular, the radiator 420 is situated on the rear side of the insulating wall 118, the radiator 420 being received in the cavity V110, while the insulating wall 118 is open towards the front of the contact plate 410. In other words, the insulating wall 118 is interposed between the power bus 124 and the radiator 420. The portion of the insulating wall 118 that serves as a support for the conductor bars 122 is preferably continuous, so as to reduce the risks of an electric arc between the conductor bars 122 and the radiator 420.

The conductor bars 122 include at least one phase bar and, optionally, a neutral bar, the neutral bar being associated with the neutral of the power source, each phase bar being associated with a respective phase of the power source. In the example illustrated, the power bus 124 comprises four conductor bars 122, the power source being a three-phase source with a neutral. The distribution assembly 100 in this case has a so-called “3P+N”, or simply 3PN, configuration.

In a variant that is not shown, the power source is three-phase, with or without a neutral, while the distribution assembly does not comprise a conductor bar associated with the neutral. In other words, the distribution assembly comprises only three phase bars, each one associated with a respective phase of the power source. The distribution assembly is then in a so-called 3P configuration.

The principles of the invention are transposable regardless of the number of phases of the power source. According to another variant that is not illustrated, the power source is single-phase, that is to say comprises only the neutral and one phase. The conductor bars then include one phase bar and the neutral bar. The distribution assembly is then in a so-called P+N, or simply PN, configuration. Regardless of the configuration, there are still a plurality of conductor bars, which include at least one phase bar and optionally a neutral bar.

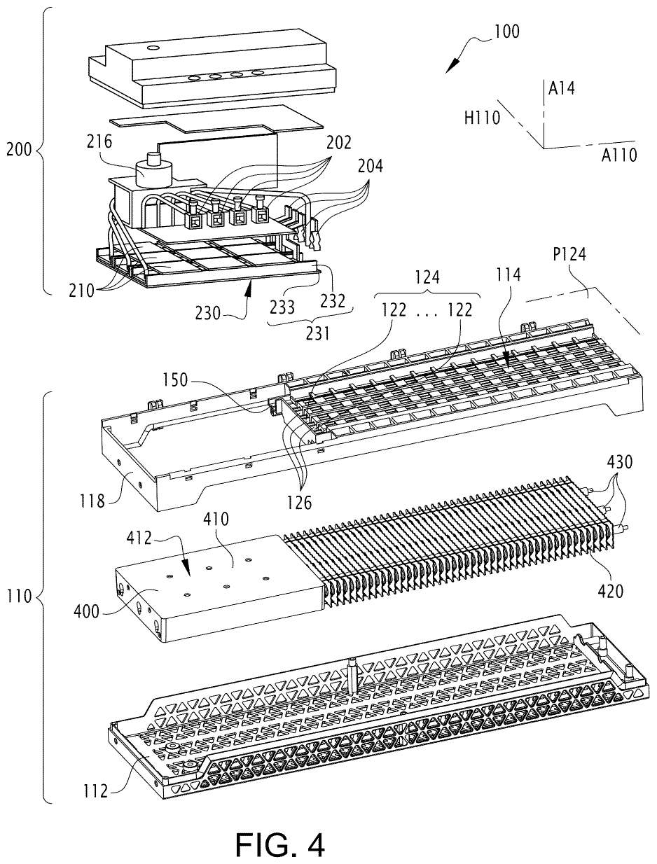

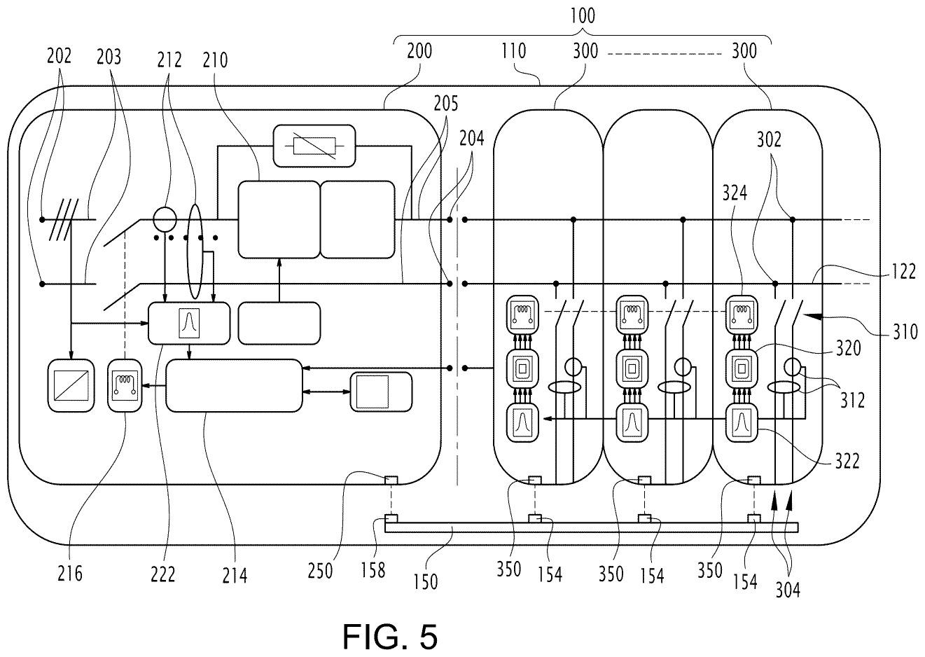

The main housing 200 will now be described, in particular with reference to FIGS. 4 and 5. In FIG. 5, the circuit of one phase is shown, the three phases being represented, according to a known convention, by three parallel lines through the circuit.

The main housing 200 comprises input terminals 202, which are configured to be connected to the neutral and to each phase of the power source, and output terminals 204, which are configured to be connected to the conductor bars, each output terminal being associated with a respective conductor bar and with a respective input terminal. The input terminals 202 are in this case screw terminals. Advantageously, the output terminals 204 are connecting clips, which are each provided for reversible connection to a respective conductor bar 122, by means of a connection movement oriented towards the rear of the distribution assembly 100. Thus, during the movement for connecting the output terminals 204 to the conductor bars 122, the rear face of the main housing 200 comes to bear against the contact face 412.

For each input terminal 202, the main housing has a corresponding input line 203, which is connected to the corresponding input terminal 202, and an output line 205, which is connected to the associated output terminal 204.

The main housing 200 comprises static switching means 210, which are switchable between an on configuration, in which each input terminal 202 associated with a phase of the power source is electrically connected to the associated output terminal 204, the main housing 200 being in an on configuration, and an off configuration, in which the passage of an electric current between the input terminal 202 and the associated output terminal 204 is prevented, the main housing 200 being in an off configuration.

The static switching means 210 are power switches based on semiconductor components, preferably insulated-gate field-effect transistors, known as JFETs or MOSFETs, and are thus referred to as “static” as opposed to moving-contact switching means. The static switching means 210 are connected in series between the input line 203 and the associated output line 205. The static switching means 210 are depicted schematically in FIGS. 4 and 5.

In operation, the switching means 210 release heat, of the order of a few tens of watts. The switching means 210 are advantageously disposed so as to promote the transfer of at least part of the released heat to the cooling device 400.

In particular, the switching means 210 are advantageously arranged against a rear wall 231 of the main housing 200, preferably in surface contact with the rear wall 231. The rear wall 231 is present, for example, when the main housing 200 is able to be removed from the contact plate 410. The rear wall 231 forms the rear face 230, the rear face 230 being oriented away from the switching means 210. The rear wall 231 is thus interposed between the switching means 210 and the contact plate 410 when the main housing 200 is mounted on the distribution device 110, such that part of the heat generated by the switching means 210 in operation is transferred to the contact plate 410 through the rear wall.

The rear wall 231 is made of a thermally conductive and electrically insulating material. In the example illustrated, the rear wall 231 is formed of an assembly of an insulating element 232, which is electrically insulating and made of synthetic polymer material, and of a copper plate 233, which confers rigidity on the assembly while promoting thermal conductivity, the copper plate 233 forming the rear face 230 and bearing against the contact plate 410 when the main housing 200 is mounted on the distribution device 110. In a variant that is not illustrated, the copper plate 233 is omitted, and so the rear face 230 is directly formed by the insulating element 232.

The main housing 200 comprises main detection means 212, which are configured to measure electrical quantities at the output terminals and to detect an electrical fault depending on the values measured. The main detection means 212 are in this case depicted schematically by measuring loops, which are in this case arranged on the output lines 205. The schematic depiction of the main detection means does not limit the type of electrical faults that the main detection means 212 are able to detect.

The main housing 200 is configured to pass from the on configuration to the off configuration when the main detection means 212 detect a first electrical fault, in particular a short circuit.

The main housing 200 comprises an electronic control unit 214, or ECU, which is configured to control the static switching means 210, in other words to switch the static switching means 210 between the on configuration and the off configuration. The control unit 214 is also configured to analyse the values measured by the main detection means 212 and to determine, on the basis of predefined criteria corresponding to a predetermined type of electrical fault, the existence of an electrical fault of the predetermined type. In FIG. 5, the use of predefined criteria is depicted schematically by the presence of a so-called “primary” filter 222, the primary filter 222 being interposed between the main detection means 212 and the control unit 214.

Thus, the main detection means 212 are configured to detect electrical faults of the short-circuit type. For example, the main detection means 212 include current sensors, in particular one current sensor per phase, while the control unit 214 is configured to analyse the measurements taken by the current sensors and to detect a short circuit.

Preferably, the main detection means 212 also include a differential current detection device. There are several types of differential fault, which are defined in particular in the standard IEC 60755:2017. In particular, the types of electrical fault include the fact that the electrical signal is rectified, that the signal includes a high-frequency component, the calibre—for example 30 mA or 300 mA—, etc. It will be understood that the primary filter 222 defines criteria for detection of electrical faults by the control unit 214 of the main housing 200. Preferably, the primary filter 222 defines criteria for detection of a type of predetermined differential fault, the predetermined differential fault being chosen from the faults defined in the standard IEC 60755:2017.

The following description corresponds to the preferred case in which the electrical fault in question is a short circuit, the principles of the invention being transposable to other types of electrical fault. A switch-off time ΔC is defined as being a period of time between the time at which the electrical fault is detected and the passage into the off configuration. The switch-off time ΔC thus includes the time required to analyse the measurements taken by the main detection means, the time required to send an opening order to the static switching means 210, and the switching time of the static switching means 210 once the opening order has been sent. The switching time of the static switching means 210 depends on the structure of the static switching means and is less than 1 microsecond—μs—. Thus, the switch-off time ΔC is substantially linked to the operation of the control unit 210. Typically, the switch-off time ΔC is in the region of a microsecond or several tens of microseconds, for example between 5 μs and 500 μs.

Preferably, the main housing 202 also comprises, for each input terminal 202, a general switching device 216, which is a switching device with separable contacts, in this case a disconnector. The general switching device 216 is controlled by the electronic control unit 214 and makes it possible to electrically disconnect the power source from the distribution assembly 100, for example in the event of a malfunction of the static switching means 210. The general switching device 216 is interposed between each input terminal 202 and the static switching means 210.

Advantageously, the distribution device 100, and by extension the distribution assembly 100, also comprises a transfer bus 150. The transfer bus 150, which is depicted on its own in FIG. 3 b), is provided for operation in order to supply energy to each protection device 300 in the mounted position, that is to say when connected to the conductor bars 122. The transfer bus 150 is therefore, in this case, an energy transfer bus, in other words a power supply bus, which is separate from the power bus 124. According to one illustrative example, the transfer bus 150 operates under a voltage of several tens of volts, for example 50 V DC, while the power bus 124 operates under a voltage of 400 V three-phase AC. The transfer bus 150 is in this case a separate part, which is joined to the rest of the distribution device 110.

The transfer bus 150 comprises a body 152, which is made of an electrically insulating material, which has an elongate shape extending along the power bus 124. Thus, the transfer bus 150 extends along the main axis A110.

The power bus 150 defines several mounting zones 154, which are provided to be connected to each protection device in the mounted position, the mounting zones 154 being distributed, preferably regularly, along the main axis A110 and being each associated with a single position along the main axis A110. The transfer bus 150 comprises preferably fifteen mounting zones 154, which are in this case spaced apart from one another at a spacing of 18 mm. Other spacings are possible, of course. In a variant that is not shown, the mounting zones 154 are spaced apart from one another at a spacing of 9 mm.

The transfer bus 150 comprises at least two transfer lines 156, which extend along the body 152 and which are configured to be electrically connected to each protection device 300 in the mounted position. The transfer lines 156 are in this case power supply lines.

The transfer bus 150 also comprises a connection zone 158, which is provided for the connection of the main housing 200 in the mounted position on the distribution device 110. For example, the main housing 200 comprises a complementary terminal block 250, which is configured to cooperate with the connection zone 158, such that the main housing is electrically connected to the transfer lines 156. In the preferred example illustrated, the main housing 200 draws electrical energy necessary for the power supply of the transfer bus 150 from the neutral and the phases of the power source, between the static switching means 210 and the general switching device 216, the electrical energy thus supplied being available to the protection devices 300 for the operation thereof.

The transfer bus 150 is formed here by a printed circuit board, the transfer lines 156 being conductor tracks formed on the surface of the board, while the mounting zones 154 and the connection zones 158 are lugs formed in the substrate of the board. In the example illustrated, the transfer bus 150 advantageously incorporates a communication bus between the main housing 200 and each protection device 300.

The protection devices 300 will now be described.

Each protection device 300 thus comprises an incoming terminal block which is able to be reversibly connected to the conductor bars 122 and which comprises at least two incoming terminals 302, each incoming terminal 302 being configured to be electrically connected to a respective conductor bar 122. For each protection device 300, the incoming terminals 302 include a neutral incoming terminal, which is configured to be electrically connected to the neutral bar, and between one and three other incoming terminals, which are each configured to be connected to a respective phase bar. Each protection device 300 is configured to be mounted, reversibly, on the power bus 114, such that each incoming terminal 302 is electrically connected to the corresponding conductor bar 122.

Each protection device 300 also comprises an outgoing terminal block, which is configured to be connected to an electric load and which comprises outgoing terminals 304, each outgoing terminal 304 being respectively associated with a respective incoming terminal 302. The outgoing terminals 304 are depicted schematically in FIG. 5.

In the non-limiting example illustrated, the protection devices 300 have different widths, the width being measured along the main axis A110. Thus, the protection devices 300 are in this case distributed in two sub-groups, which correspond to two different widths, with thin protection devices 300 and wide protection devices 300, which are substantially three times wider than the thin protection devices 300. Other widths of protection devices 300 are conceivable, of course. The width of the protection devices 300 is preferably a multiple of the spacing between each mounting zone 154 of the transfer bus 150, i.e., in this case, 18 mm. In a variant that is not shown, the protection devices 300 have a width equal to a multiple of 9 mm.

In the example illustrated, a protection device 300 configured to supply power to a single-phase electric load advantageously has a width of 18 mm, while a protection device 300 configured to supply power to a three-phase electric load has a width of three times 18 mm, i.e. 54 mm.

The thinnest protection devices 300 are configured to be connected to two conductor bars 122, including a neutral bar and a phase bar, while the wide protection devices 300 are configured to be connected to four conductor bars 122. The principles of the invention are applicable regardless of the number of phases to which each of the protection devices 300 is connected.

Preferably, the distribution device 110 is provided to receive five protection devices 300, which each comprise four incoming terminals, in other words five wide protection devices 300. According to an example that is not illustrated, the distribution assembly 100 comprises five protection devices 300, which each comprise four incoming terminals 302. Consequently, the distribution device 110 is also provided to receive fifteen thin protection devices 300, each comprising two incoming terminals 302.

The conductor bars 122 each comprise:
a power supply portion 126, which is configured to be connected to an associated output terminal 204 of the main housing 200 in a mounted configuration of the main housing, and
a connection portion 128, which extends on the same side as the power supply portion 126. The connection portions 128 are geometrically situated on a front side of the connection plane P124 and jointly define a connection zone of the power bus 124.

In FIG. 4, only the power supply portions 126 of the conductor bars 122 are visible, the connection portions 128 being hidden. The connection zone is configured to receive at least one protection device 300, such that the protection device is connected to the power bus 124. The protection device 300 is then able to be connected to an electric load so as to supply the electric load with electric power.

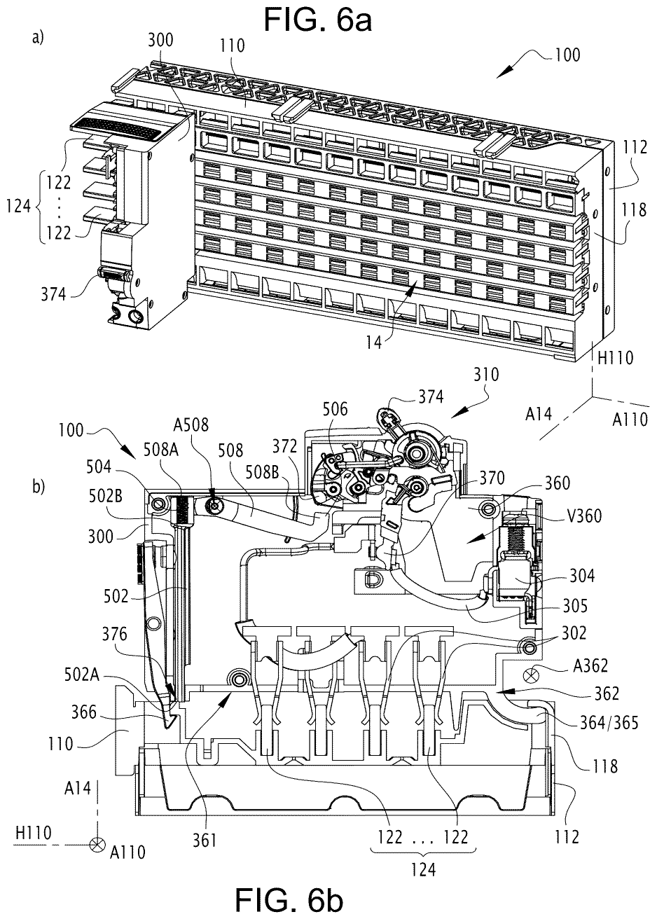

Each protection device 300 comprises a switching mechanism 310. The switching mechanism is in this case an electromechanical mechanism, which is analogous to the switching mechanism described in EP-4 064 317-A1. Each switching mechanism 310 is interposed between each incoming terminal 302 and the corresponding outgoing terminal 304. The switching mechanism 310 is described below with reference to FIGS. 6 to 8.

Each protection device 300 comprises secondary detection means 312, which are configured to measure electrical quantities at the corresponding outgoing terminals and to detect at least one electrical fault of a predetermined type, that is to say corresponding to predetermined detection criteria. The secondary detection means 312 are in this case depicted schematically by measuring loops, which are in this case arranged on the wires connecting the incoming terminals 302 to the outgoing terminals 304. The schematic depiction of the secondary detection means 312 does not limit the type of electrical faults that the secondary detection means are able to detect. Thus, the secondary detection means 312 are configured to detect electrical faults of the short-circuit type.

For example, the secondary detection means 312 include current sensors, in particular one current sensor per phase, while the protection device 300 comprises a microcontroller 320, which receives the measurements from the current sensors and which is able to determine whether the current or currents measured exceed(s) a short-circuit threshold.

The microcontroller 320 is supplied with power via the transfer bus 150. To this end, each protection device 300 comprises a transfer terminal block 350, which comprises transfer terminals—not depicted—, the transfer terminal block 350 being configured to be connected to the transfer bus 150 such that each transfer terminal is electrically connected to a respective transfer line 156. The transfer terminal block 350 is therefore, in this case, a power supply terminal block. The transfer terminals are different from the incoming terminals 302 or the outgoing terminals 304.

Preferably, the secondary detection means 312 also include a differential current detection device. Preferably, the microcontroller 320 is also configured to evaluate the differential current measurement with the aid of a so-called “secondary” filter 322, the secondary filter 322 being stored in advance in a memory of the microcontroller 320 of the protection device 300 and being designed to detect a differential fault.

It will be understood that the secondary filter 322 defines the detection criteria for the electrical faults detected by the microcontroller 320 of the protection device 300. Preferably, the secondary filter 322 defines detection criteria for a predetermined differential fault type, which is chosen from the faults defined in the standard IEC 60755:2017.

Each microcontroller 320 is supplied with electrical energy for operation via the transfer bus 150, independently of the configuration, armed or tripped, of the switching mechanism 310 of the outgoing housing 300.

Each protection device 300 in this case comprises an actuator 324, which is configured to move the switching mechanism 310 into the open position when the actuator receives a tripping signal, the microcontroller 320 being configured to send the tripping signal to the actuator 324 during the detection of an electrical fault, in particular a short circuit or a differential fault. More generally, each protection device 300 is configured to pass from the closed configuration to the open configuration when the secondary detection means 312—and, by extension, the microcontroller 320—detect an electrical fault.

The operation of the protection assembly 100 in the event of a short circuit is described, this operation being transposable to other types of electrical fault, in particular to differential faults. An opening time ΔO is defined as being a period of time between the time at which the electrical fault is detected by the microcontroller 320 and the start of the movement of the moving contacts of the switching mechanism 310, from the closed position to the open position. In the example illustrated, the opening time ΔO therefore includes the time during which the microcontroller 320 sends the switching order to the actuator 324. Typically, the opening time ΔO is in the millisecond range, for example from 2 ms to 9 ms.

In a minimal configuration of the distribution assembly 100, the distribution assembly comprises the distribution device 110, on which the main housing 200 and one protection device 300 are mounted. It is presumed that the distribution assembly 100 is connected to a power source, via the input terminals 202, while an electric load is connected to the outgoing terminals 304.

In a normal operating configuration, the main housing 200 is initially in the on configuration, while the protection device 300 is initially in the closed configuration. Thus, the outgoing terminals 304 are each electrically connected to a respective output terminal 204, via the associated conductor bar 122. When an electrical fault occurs, for example in the event of a short circuit linked to a failure of the electric load, the electrical fault is detectable both by the main housing 200, by means of the main detection means 212, and by the protection device 300, by means of the secondary detection means 312.

In other words, the criteria for detection of an electrical fault that are used by the main housing 200 are identical to the criteria for detection of an electrical fault that are used by the protection device 300 in question.

Numerous types of electrical faults are conceivable. By way of illustration, in the event of a short circuit, a short-circuit current may reach several times, for example 5 times, the value of a nominal operating current. Other examples of electrical faults include overcurrents, differential current faults, etc. By comparison with short circuits, the electric currents involved in the event of overcurrents or differential faults are much lower, for example less than 1.2 times the value of the nominal operating current.

In the example illustrated, the detection criteria are defined by the detection filters, i.e., in this case, the primary filter 222 for the main housing 200 and the secondary filter 322 for the protection device 300. It is assumed that the primary filter 222 and the secondary filter 322 functionally define the same detection criteria, meaning that the primary filter 222 and the secondary filter 322 are functionally identical to one another, such that the main housing 200 and the protection device 300 are configured to detect electrical short circuits according to the same criteria. The main housing 200 and the secondary housing 300 are thus naturally synchronized as regards the detection of electrical short circuits.

The distribution assembly 100 is configured such that, when an electrical fault corresponding to the criteria of the primary filter 222 and of the secondary filter 322 occurs:
the protection device 300 detects the electrical fault by means of the secondary detection means 312, and then the microcontroller 320 of the protection device orders the switching mechanism 310 to pass into the open position,
while the main housing 200 detects the same electrical fault by means of the main detection means 212, and then the control unit 214 of the main housing 200 orders the switching means 210 to pass into the off configuration.

Given the proximity of the main housing 200 with the protection device 300, the detection of the same electrical fault by the main housing 200 and by the protection device 300 is considered to be simultaneous.

The distribution assembly 100 is configured such that the main housing 200 passes into the off configuration before the first housing passes from the closed configuration to the open configuration. In other words, the switching time ΔC is less than the opening time ΔO, such that when the moving contacts of the switching mechanism 310 start to move from the closed position to the open position, no current is flowing in the power bus 114. The moving contacts of the switching mechanism 310 open without an electric arc being generated, thereby making it possible to reduce the wear on the moving contacts and contributing to the durability of the protection devices 300. By virtue of the invention, the protection devices 300 are protected by the main housing 200 in the event of electric faults, in particular in the event of short circuits. Consequently, the protection devices 300, and in particular the switching mechanism 310, do not need to be designed to withstand short-circuit power outages, which involve the highest energies among the various types of electrical fault considered. It is thus possible to manufacture less expensive protection devices 300, which are also easy to change by virtue of the modular structure of the distribution assembly 100.

In a variant that is not shown, the master housing 200 comprises autonomous protection against electrical faults of the overcurrent and/or differential type. For example, an overcurrent threshold as defined at the main housing is equal to the sum of the nominal current intensities of each slave device.

Once the protection device 300 is in the open configuration, the main housing 200 is configured to pass from the off configuration to the on configuration following a predetermined waiting time ΔW, the waiting time ΔW being greater than the opening time.

Consideration is given to the case in which the distribution assembly comprises two or more protection devices 300, the two protection devices 300 including a first housing and a second housing, which are jointly connected to the conductor bars 122. In other words, the two protection devices 300 are mounted on the same distribution device 110. During normal operation of the distribution assembly 100, the main housing 200 is initially in the on configuration, while the first housing 300 and the second housing 300 are each initially in the closed configuration. It is assumed that the first housing 300 and the second housing 300 are each connected to a respective electric load.

When an electrical fault occurs at the outgoing terminals 304 of the first housing 300, for example following a failure of the electric load connected to the first housing 300, the first outgoing housing 300 detects this electrical fault by means of the secondary detection means 312 of the first housing 300 and, simultaneously, the main housing 200 also detects this electrical fault by means of the main detection means 212. As before, the main housing 200 passes into the off configuration before the first housing 300 passes from the closed configuration to the open configuration, while the second housing 300 remains in the closed configuration.

Next, the main housing 200 passes from the off configuration to the on configuration following the waiting time ΔW, the second housing 300 remaining in the closed configuration. The waiting time ΔW is short enough for the power interruption undergone by the electric load associated with the second housing 300 not to have a negative impact. In practice, the waiting time ΔW is less than 20 ms, preferably less than 15 ms, more preferably less than 10 ms.

In the example illustrated, each protection device 300 comprises a microcontroller 320, which analyses the measurements from the secondary detection means 312 and determines the existence of an electrical fault, in particular a differential fault. This requires the microcontroller to be supplied with power by an electrical energy source, in this case via the transfer bus 150. The principles of the invention are transposable to the case in which the protection devices 300 do not comprise a microcontroller, the actuator 324 being, for example, supplied with power directly by the current differential measured by the secondary detection means 312.

In the example illustrated, the transfer bus 150 is a power supply bus, which is configured to supply operating energy to each protection device 300, in particular to the power supply of the microcontroller 320 of each protection device 300. In a variant that is not illustrated, the transfer bus 150 also serves to transfer data between each microcontroller 320 and the control unit of the main housing 200. For example, the transfer of information passes through the same transfer lines 156 as are used for the transfer of energy. In an alternative that is not illustrated, the transfer bus 150 comprises additional information transfer lines, which are different from the transfer lines 156 and which are provided on the transfer bus 150.

The mounting and dismantling of the protection devices 300 on/from the distribution device 110 will now be described, with reference to FIGS. 6 to 8. One protection device 300, according to a first embodiment, is shown in the figures. The information provided in relation to this protection device 300 is transposable to the other protection devices 300 or to other electrical protection devices, in particular to protection devices having a different width or comprising a different number of incoming terminals 254.

The protection device 300 comprises a housing 360, which is configured to be mounted, reversibly and by means of a mounting movement, on the distribution device 110. The protection device 300 is then in a mounted position, in which a rear face 361 of the housing 360 is oriented towards the distribution device 110, as illustrated in FIGS. 6a and 6b. The incoming terminals 302 protrude through the rear face 361 and are electrically connected to the conductor bars 122.

Along a first edge 362 of the rear face 361, the housing 360 comprises a fastening member 364, which in this case includes a portion 365 of curved shape, preferably in the form of a circular arc. The fastening members 364 is provided to cooperate, in particular by way of a form fit, with the distribution device 110, such that the mounting movement of the protection device 300 is a rotational movement about a mounting axis A362 situated close to the first edge 362, the rear face 361 of the protection device 300 being close to the distribution device 110. In the example illustrated, the fastening member 364 is in the form of a circular arc, with a substantially constant curvature, the mounting axis A362 being situated substantially at the centre of curvature of the fastening member. Other arrangements are possible, of course. The mounting axis A362 is preferably parallel to the main axis A110. Preferably, the mounting axis A362 is situated at the bottom of the distribution device 110 when the protection assembly 100 is in a normal use configuration, fastened to the bottom 14 of an electrical panel 10.

Advantageously, the fastening member 364 also includes a retaining member 366, in this case a peg, which is spring-mounted and which is situated at a distance from the first edge 362. The peg is in this case situated close to a second edge 368 of the rear face 361, the second edge 368 being situated away from the first edge 362. The retaining member 366 is configured to cooperate, in particular by way of a form fit, with the distribution device 110, so as to keep the protection device 300 in the mounted position. The retaining member 366 is advantageously reversible, manually and without a tool, such that a user can easily dismantle the protection device 300 from the distribution device 110. Starting from the mounted position of the protection device 300, a dismantling movement is a movement opposite to the mounting movement, that is to say a rotational movement about the mounting axis A362, the rear face 361 of the protection device 300 being moved away from the distribution device 110.

In FIGS. 6 to 8, the housing 360 is partially omitted so as to reveal the interior of the protection device 300, in particular the switching mechanism 310. Each incoming terminal 302 is connected to the corresponding outgoing terminal 304 by a conducting path 305. One conducting path 305 is shown in the figures, the principles of the invention, which are described in relation to this conducting path 305, being, of course, transposable to the other conducting paths of the protection device 300.

Thus, for at least one conducting path 305 of the protection device 300, the switching mechanism 310 comprises a moving contact 370, which is interposed between the incoming terminal 302 and the outgoing terminal 304 that correspond to this conducting path 305. By extension, the moving contact 370 forms a part of the conducting path 305 and thus forms part of the conducting path 305.

The moving contact 370 is able to move with respect to the housing 360 between a conducting position, in which the first moving contact 362 electrically connects the ingoing terminal 302 in question to the corresponding outgoing terminal 304, and an isolating position, in which the ingoing terminal 302 and the outgoing terminal 304 are electrically isolated from one another. When the moving contact 370 is in the conducting position, the protection device 300 is in a closed configuration, whereas when the moving contact 370 is in the isolating position, the protection device 300 is in an open configuration.

The switching mechanism 310 is configured to switch between:
an armed configuration, in which the switching mechanism 310 places the moving contact 370 in the conducting position, and
a tripped configuration, in which the switching mechanism 310 places the moving contact 370 in the isolating position.

In a known manner, as described in particular in EP-4 064 317-A1, the switching mechanism 310 comprises a tripping device 372, which is movable between a neutral position and an excited position, the tripping device 372 being configured to switch the switching mechanism into the tripped configuration when the tripping device is in the excited position. In FIG. 6 b), the switching mechanism 310 is depicted in the armed configuration, the tripping device 372 being in the neutral position.

The switching mechanism 310 advantageously comprises a handle 374, which is provided so that a user can manually trip the switching mechanism 310, that is to say switch the switching mechanism 310 from the armed configuration to the tripped configuration. The handle 374 also makes it possible to rearm the switching mechanism 310, that is to say switch the switching mechanism 310 from the tripped configuration to the armed position. The rearming of the switching mechanism 310 is prevented when the tripping device 372 is in the excited position.

The protection device 300 comprises a safety mechanism 500, which includes:
a support portion 502, which is movable between a retracted position and an advanced position, the support portion being accessible through a slot 376 provided in the housing 360 and being configured to be pushed back into the retracted position by the distribution device when the protection device 300 is mounted on the distribution device 110 by means of the mounting movement,
a return member 504, which tends to return the support portion 502 to the advanced position,
a tripping portion 506, which is movable between an activating position, in which the tripping portion 506 pushes the tripping device 372 back from the neutral position to the excited position, and a set-back position, in which the tripping portion 506 does not push back the tripping device,
a transmission device 508, which connects the support portion 502 to the tripping portion 506 such that when the support portion 502 is in the retracted position, the tripping portion 506 is in the set-back position, the safety mechanism 500 being in a set-back configuration, whereas when the support portion 502 is in the advanced position, the tripping portion 506 is in the activating position, the safety mechanism 500 being in an activating configuration.

The safety mechanism 500 is in the set-back configuration when the protection device 300 is in the mounted position on the distribution device 110. The safety mechanism 500 is configured such that, during a dismantling movement of the protection device 300, the safety device 500 passes from the set-back configuration to the activating configuration before the incoming terminal 302 is disconnected from the power bus 124. In other words, if the switching mechanism 310 is initially in the armed configuration, the safety device 500 switches the switching mechanism 310 into the tripped configuration, via the tripping device 372, before the incoming terminal 302 is disconnected from the power bus 124. The corresponding conducting circuit 305 is therefore open before the incoming terminal 302 in question is disconnected from the power bus 124, thereby preventing the occurrence of any electric arcs between the incoming terminal 302 and the power bus 124. The dismantling of the protection device 300 is thus safeguarded, even if the protection device 300 was initially “hot”, that is to say in the armed configuration and with an electric current flowing through the conducting path 305. Such a “hot” dismantling possibility is also referred to as a “hotswap”.

In the example illustrated, the slot 376 is advantageously provided in the rear face 361 of the housing 360, such that a user cannot interfere with the safety mechanism 500 when the protection device 300 is mounted on the distribution device 110 or during the mounting or dismantling movements.

In the first embodiment, the housing 360 forms an internal volume V360, in which the switching mechanism 310 and the safety mechanism 500 are jointly received.

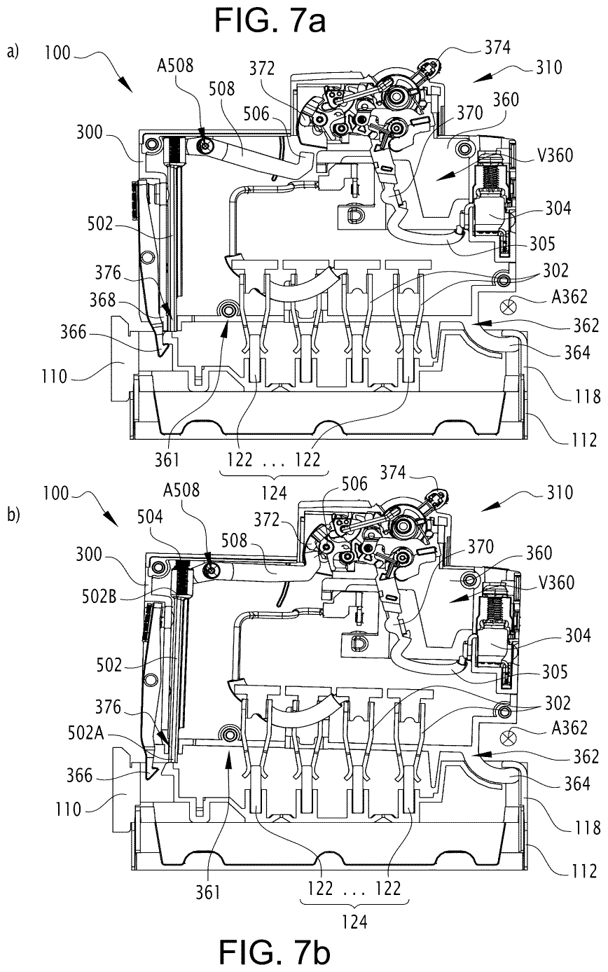

The support portion 502 is in this case a rod, which is advantageously made of an insulating material, for example a polymer material. The rod is guided in translation with respect to the housing 360 and leads out onto the rear face 361 through the slot 376. In the advanced position, a first end 502A of the rod protrudes through the rear face 361, as illustrated in FIG. 7 b), 8 a) and 8 b). The return member 504 is in this case a spring, which exerts, on a second end 502B of the rod, a force that tends to return the rod into the advanced position. Thus, the retracted position and the advanced position of the support portion 502 are in this case two axial positions. The slot 376 is advantageously provided at a distance from the first edge 362, so as to increase the amplitude of the axial movement of the support portion 502. The movement of the tripping portion 506 is for its part also increased, making it possible to trip the switching mechanism 310 before the incoming terminals 302 are disconnected from the conductor bars 122.

The transmission device 508 is in this case a lever, which is mounted pivotably with respect to the housing 360 about a pivot axis A508, which in this case is an axis parallel to the main axis A110. The transmission device 508 comprises a first end 508A, by which the transmission device is connected to the support portion 502, and a second end 508B, which is situated at the opposite end from the first end 508A with respect to the pivot axis A508 and which in this case is in the form of a hook forming the tripping portion 506. Thus, the activating position and the neutral position of the tripping portion 506 are in this case two angular positions, about the pivot axis A508, of the second end 508B of the transmission device 508.

The operation of the safety mechanism 500 will now be described.

In FIGS. 6a and 6b, the protection device 300 is mounted on the distribution device 110. Each incoming terminal 302 is connected to the corresponding conductor bar 122. The switching mechanism 310 is in the closed configuration. The support portion 502 has been pushed back into the retracted position, and also the safety mechanism 500 is in the neutral configuration and does not interfere with the operation of the switching mechanism 310, in particular if the user wishes to manually trip the switching mechanism 310 with the aid of the handle 374.

In this way, the distribution assembly 100 is then in the configuration in FIG. 7 a), in which the switching mechanism 310 is in the tripped configuration. The safety mechanism 500 is in the neutral configuration and does not interfere with the operation of the switching mechanism 310, in particular if the user wishes to manually rearm the switching mechanism 310 with the aid of the handle 374—in long as this is possible in the absence of electrical faults.

If, starting from the configuration in FIGS. 6a and 6b, the operator initiates the dismantling movement while the switching mechanism 310 is still in the armed configuration, during the dismantling movement, the support portion 502 passes gradually from the retracted position to the advanced position, and the tripping portion 506 passes gradually from the set-back position to the activating position, bushing the tripping device 372 back from the neutral position to the excited position, bringing about the tripping of the switching mechanism 310. The distribution assembly 100 is then in the configuration in FIG. 7 b), in which the switching mechanism 300 is already tripped, while the incoming terminals 302 are still connected to the power bus 124.

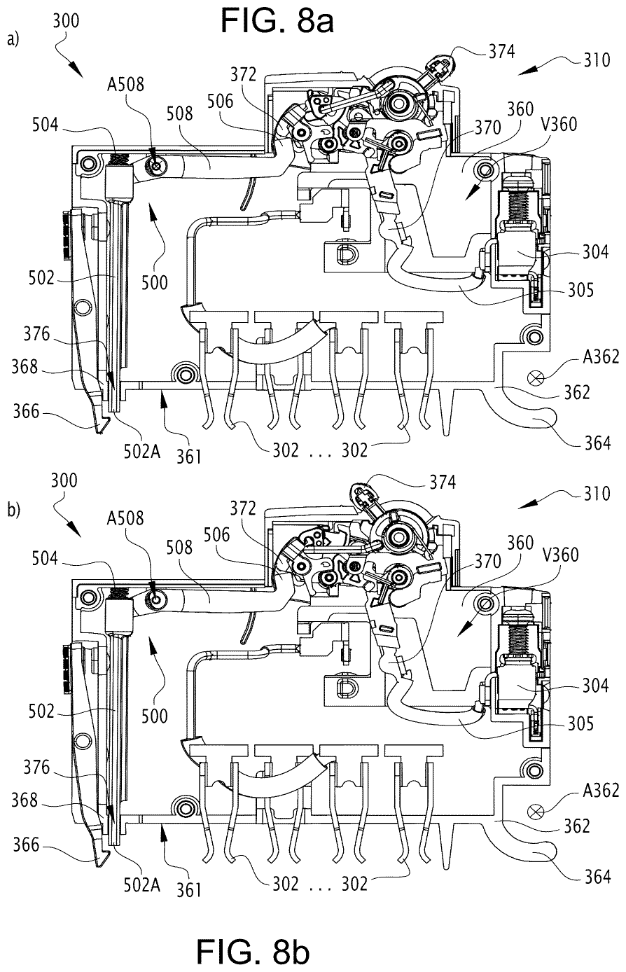

While the dismantling movement continues, the protection device 300 is in the configuration in FIG. 8 a). Starting from this configuration, the safety mechanism 500 remains in the activating configuration, pushing the tripping device 372 back into the excited position. It is thus impossible to rearm the switching mechanism 310, as illustrated in FIG. 8 b), in which the moving contact 370 is in the isolating position, despite the fact that the handle 374 is being held in the closure position by a user.

It is therefore impossible to remount on the distribution device 100 a protection device 300 which is already in the armed configuration, unless the safety mechanism is interfered with, thereby contributing to improving safety during the hot mounting of the protection device 300, that is to say during the mounting of the protection device 300 on a power bus 124 that is already energized.

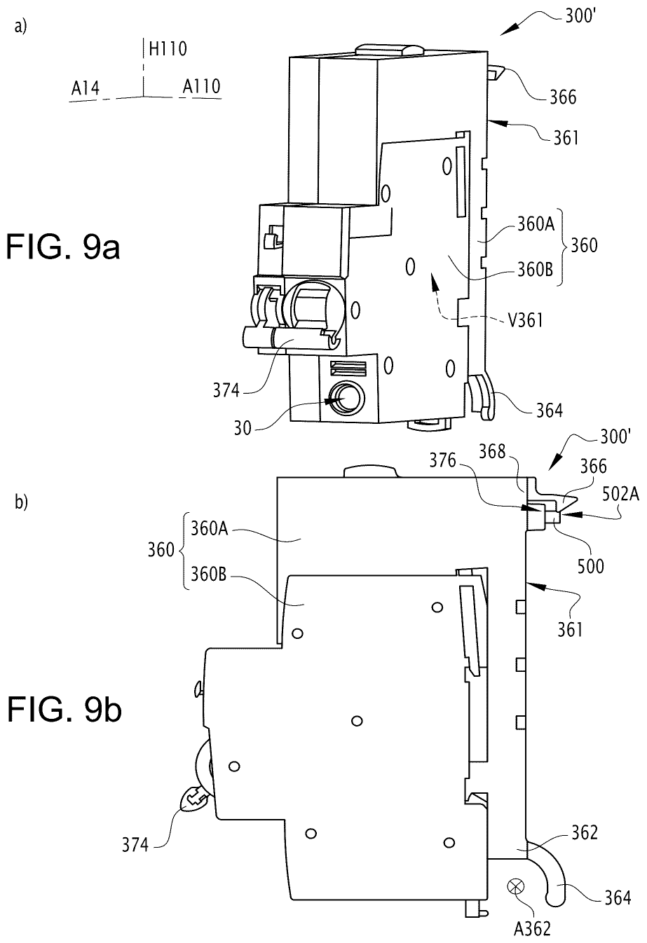

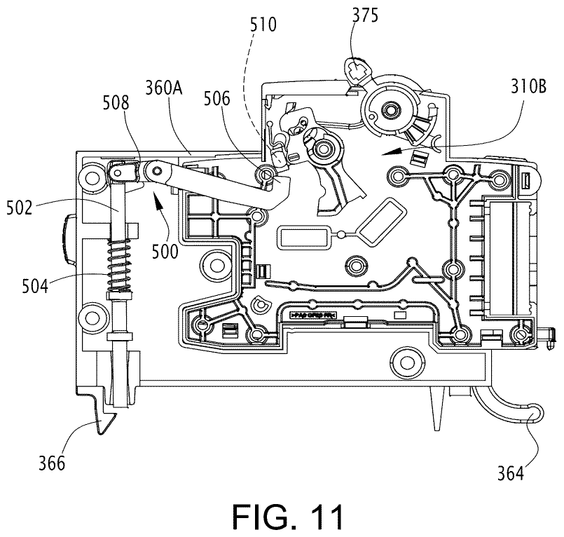

A protection device 300′ according to a second embodiment of the invention is shown in FIGS. 9 to 11. In the second embodiment, the elements that are analogous to those of the first embodiment bear the same references and function in the same way. In the following text, it is mainly the differences between the first and second embodiments that are described. Where a reference is mentioned in the description without being indicated on a figure or indicated on a figure without being mentioned in the description, it denotes the same element as the one bearing the same reference in the first embodiment.

One of the main differences of the second embodiment from the first embodiment is that, in the second embodiment, the housing 360 of the protection device 300′ is a modular housing, which includes:
a first housing 360A, which receives the safety mechanism 500, and
a second housing 360B, which is different from the first housing 360A and receives the switching mechanism.

The first housing 360A forms a cavity V361 for receiving the second housing 360B, the first housing 360A and the second housing 360B being configured to be joined to one another so as to form the housing 360 of the protection device 300′, in an assembled configuration of the housing 360, as illustrated in FIGS. 9a and 9b. The rear wall 361 of the housing 360 advantageously belongs to the first housing 360A. Preferably, the fastening member 364 and the retaining member 366 are also carried by the first housing 360A.

The protection device 300′ is depicted in the dismantled position, only one end of the support portion 502 being visible from outside the first housing 360A, the rest of the safety mechanism 500 being hidden inside the first housing 360A.

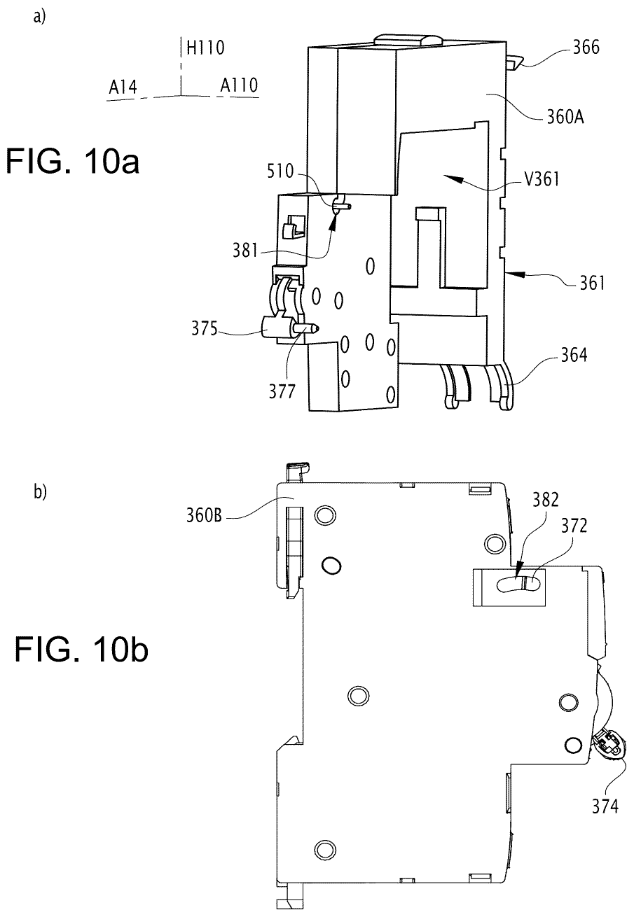

The first housing 360A is shown on its own in FIG. 10 a), while the second housing 360B is shown on its own in FIG. 10 b). The second housing 360B is, for example, part of a protection device such as a differential circuit breaker, which is advantageously able to operate independently of the first housing 360A, in other words without the safety mechanism. As explained in the following text, the modularity of the housing 360 makes it possible to add the “hot dismantling” functionality, entirely safely, to a differential circuit breaker which initially does not have same.

The first housing 360A has a first orifice 381, which opens into the cavity V361, while the safety mechanism comprises an extension 510, which is able to be activated by the tripping portion 506, which protrudes through the first orifice 381 into the cavity V361. The first orifice 381 in this case has an elongate and curved shape. The extension 510, which is also referred to as a “needle” or “finger”, in this case has a cylindrical shape with a circular section. Thus, when the tripping portion 506 moves between the set-back position and the activating position inside the first housing 360A, the extension 510 travels, through the first orifice 381, into the cavity, between a first position and a second position.

The second housing 360B has a second orifice 382, which is situated facing the first orifice 381 when the housing is in the assembled configuration. As illustrated in FIG. 10 a), the second orifice 382 advantageously has a shape analogous, if not identical, to that of the first orifice 381. When the housing 360 is in the assembled configuration, the extension 510 passes through both the first orifice 381 and the second orifice 382 and into the second housing 360B. In other words, the extension 510 extends inside the second housing 360B, such that when the tripping portion 506, situated inside the first housing 360A, moves from the set-back position to the activating position, the extension 510 moves from the first position to the second position and pushes the tripping device 372, situated inside the second housing 360B, back from the neutral position to the excited position.

The first housing 360A comprises an auxiliary mechanism 310B, which is a mechanical energy accumulation mechanism, comprising, for example, a spring, which is interposed between the safety mechanism 500 and the extension 510. The auxiliary mechanism 310B is switchable between an armed configuration, in which the extension 510 is in the first position, and a tripped position, in which the extension 510 is in the second position.

The auxiliary mechanism 310B comprises an auxiliary handle 375, which is provided to pass the auxiliary mechanism 310B from the tripped configuration to the armed configuration. Preferably, the auxiliary handle 375 and the handle 374 are secured to one another, such that the switching mechanism 310 and the auxiliary mechanism 310B pass jointly from the armed configuration to the tripped configuration, and vice versa. In the example illustrated, the auxiliary handle 375 and the handle 374 are secured by a pin 377.

The auxiliary mechanism is configured to switch from the armed configuration to the tripped configuration when the tripping portion 506 moves from the set-back position to the activating position. The auxiliary mechanism 310B is configured to transmit to the extension 510 enough force to switch the switching mechanism 310 from the armed configuration to the tripped configuration.

The embodiments and the variants mentioned above can be combined with one another to create new embodiments of the invention.

1. An electrical protection device comprising:
a housing which is configured to be mounted, reversibly and by means of a mounting movement, on a distribution device comprising a power bus with at least one phase, the protection device then being in a mounted position in which a rear face of the housing is oriented towards the distribution device,
a first conducting path comprising:
a first incoming terminal, which is configured to be connected to the power bus,
a first outgoing terminal, which is configured to be connected to an electric load, and
a first movable contact, which is movable with respect to the housing between a conducting position, in which the first movable contact electrically connects the first incoming terminal to the first outgoing terminal, and an isolating position, in which the first incoming terminal and the first outgoing terminal are electrically isolated from one another;
a switching mechanism, which is accommodated in the housing and which is configured to switch between:
an armed configuration, in which the switching mechanism places the first movable contact in the conducting position, and
a tripped configuration, in which the switching mechanism places the first movable contact in the isolating position;
wherein:
the switching mechanism comprises a tripping device, which is movable between a neutral position and an excited position, the tripping device being configured to switch the switching mechanism into the tripped configuration when the tripping device is in the excited position;
the electrical protection device comprises a safety mechanism, which comprises:
a support portion, which is movable between a retracted position and an advanced position, the support portion being accessible through a slot provided in the housing and being configured to be pushed back into the retracted position by the distribution device when the protection device is mounted on the distribution device by means of the mounting movement,
a return member, which tends to return the support portion to the advanced position,
a tripping portion, which is movable between an activating position, in which the tripping portion pushes the tripping device back from the neutral position to the excited position, and a set-back position, in which the tripping portion does not push back the tripping device,
a transmission device, which connects the support portion to the tripping portion such that when the support portion is in the retracted position, the tripping portion is in the set-back position, the safety mechanism being in a set-back configuration, whereas when the support portion is in the advanced position, the tripping portion is in the activating position, the safety mechanism being in an activating configuration,
the safety mechanism is in the set-back configuration when the protection device is in the mounted position on the distribution device,
the safety mechanism is configured such that, during a dismantling movement, opposite to the mounting movement, the safety device passes from the set-back configuration to the activating configuration of the tripping device before the incoming terminal is disconnected from the power bus.

2. The electrical protection device according to claim 1, wherein:
the slot is provided in the rear face of the housing.

3. The electrical protection device according to claim 2, wherein:
the housing comprises fastening members which are configured to cooperate, in particular by way of a form fit, with the distribution device such that the mounting movement is a rotational movement about a mounting axis situated close to a first edge of the rear face,
the slot is provided at a distance from the first edge.

4. The electrical protection device according to claim 1, wherein:
the housing forms an internal volume,
the switching mechanism and the safety mechanism are jointly received in the internal volume.

5. The electrical protection device according to claim 1, wherein:
the housing of the protection device is a modular housing which includes:
a first housing, which receives the safety mechanism and which has a first orifice, through which an extension of the tripping portion protrudes,
a second housing, which is different from the first housing and which receives the switching mechanism,
the first housing forms a cavity for receiving the second housing, the first housing and the second housing being configured to be joined together so as to form the housing of the protection device in an assembled configuration of the housing,
the first housing has a first orifice, which leads into the cavity, while the safety mechanism comprises an extension, which is able to be activated by the tripping portion and which extends through the first orifice into the cavity, the extension being movable between a first position and a second position when the tripping portion travels between the activating position and the set-back position,
the second housing has a second orifice, which is situated facing the first orifice when the housing is in the assembled configuration,
when the housing is in the assembled configuration, the extension extends into the second housing such that:
when the tripping portion moves from the set-back position to the activating position, the tripping portion activates the extension, the extension moving from the first position to the second position,
the extension pushes the tripping device back from the neutral position to the excited position.

6. The electrical protection device according to claim 5, wherein:
the first housing comprises an auxiliary mechanism, which is a mechanical energy accumulation mechanism, which is switchable between an armed configuration and a tripped configuration, the extension being in the first position when the auxiliary mechanism is in the armed configuration, and in the second position when the auxiliary mechanism is in the tripped configuration,
the auxiliary mechanism is configured to switch from the armed configuration to the tripped configuration when the tripping portion moves from the set-back position to the activating position,
the auxiliary mechanism is configured to transmit to the extension enough force to switch the switching mechanism from the armed configuration to the tripped configuration.

7. A distribution assembly comprising:
an example of the protection device according to claim 1, and
a distribution device configured to distribute electrical energy coming from a power source to at least one electric load, the power source comprising at least one phase,
wherein:
the distribution device comprises a power bus which comprises a plurality of conductor bars which include at least one phase bar each phase bar being associated with a respective phase of the power source,
the protection device is mounted on the distribution device, the support portion being pushed back into the retracted position by the distribution device, each incoming terminal being connected to the corresponding conductor bar.

8. The distribution assembly according to claim 7, wherein:
the conductor bars extend parallel to one another along a main axis of the distribution device,
the conductor bars are provided for the simultaneous mounting of a plurality of examples of the protection device that are aligned alongside one another along the main axis.

9. An electrical panel comprising:
a case delimiting an enclosure and having an end wall,
the distribution assembly according to claim 6,
wherein the distribution device is fastened to the end wall of the case.

10. The electrical protection device according to claim 1, wherein the power bus comprises a neutral.

11. The distribution assembly according to claim 7, wherein the power source comprises a neutral.

12. The distribution assembly according to claim 11, wherein the plurality of conductor bars include a neutral bar, the neutral bar being associated with the neutral of the power source.
